(19) United States
(12) Patent Application Publication
(10) Pub. No.: US 2017/0076376 A1
(43) Pub. Date: Mar. 16, 2017

(54) Margin Requirement Based on Intrinsic Value of Index CDS

(71) Applicant: Chicago Mercantile Exchange, Inc., Chicago, IL (US)

(72) Inventors: Evren Baysal, Chicago, IL (US); Panagiotis Xythalis, Scotch Plains, NJ (US); Sixiang Li, Chicago, IL (US); Lu Lu, Pittsburgh, PA (US)

(21) Appl. No.: 14/849,914

(22) Filed: Sep. 10, 2015

(51) Int. Cl. G06Q 40/06

(52) U.S. Cl. CPC G06Q 40/06

(57) ABSTRACT

A computer system may access data describing positions in a portfolio. The portfolio positions may include a position in an index credit default swap corresponding to K separate credit entities. The computer system may calculate at least one margin component based on intrinsic values of the index credit default swap at multiple times t. An intrinsic value at a time t may be represented by a sum of weighted prices, at that time t, of single name credit default swaps corresponding to the K credit entities. The computer system may also calculate data representing a margin requirement that is based at least in part on the at least one margin component and may transmit data representing the margin requirement.

### BACKGROUND

A credit default swap (CDS) is a financial product that may be used to hedge risk and/or for other purposes. A CDS can take several forms. As the name implies, a “single name” CDS names a single corporation or other credit entity. A buyer of a single name CDS agrees to make one or more payments to the seller of that CDS. In return for the agreed-upon payments, the CDS seller agrees to make a designated payout if the credit entity named by the CDS goes into default during the tenor of that CDS. Default events may be defined by the CDS and may include, e.g., bankruptcy, failure to pay debts, etc.

An index CDS names multiple credit entities, with that collection of entities sometimes known as a “basket.” For example, some types of index CDS may name a basket of 100 or more different corporations. As with a single name CDS, an index CDS buyer agrees to make one or more payments to the seller. In return for those payments, the seller agrees to make a designated payment for each of the named credit entities (or “names”) in the index CDS basket that goes into default during the index CDS tenor.

At any given time during its tenor, an executed CDS (i.e., a CDS that has been entered into by a buyer and a seller) has a market value. For example, assume that a buyer of a single name CDS relating to XYZ Co. agrees to pay $100 to the seller. Further assume that, at some time after the buyer and the seller execute that CDS, the credit-worthiness of XYZ Co. deteriorates. Because of that deterioration, the market price of a CDS to obtain similar protection against XYZ Co. default is now $110. For the buyer who paid $100 for the executed single name CDS naming XYZ Co., the buyer's position in that executed CDS has gained value. Conversely, the seller's position in that executed CDS has lost value. If XYZ Co. were to default, the value of the buyer's position in the executed CDS would jump to the amount of the agreed payout, less the original purchase price. The value of the seller's position would vary in the opposite direction upon XYZ Co. default.

Values of buyer and seller positions in a CDS can also vary in other ways. For instance, assume that the credit worthiness of XYZ Co. improves after execution of the CDS from the previous example. Because of that improvement, the new market price for a similar CDS naming XYZ Co. may have dropped to $90. This would represent a decrease in the value of the buyer's position in the executed CDS and an increase in the value of the seller's position.

The value of a position in an executed index CDS can vary in ways similar to those described above. However, the effect of any one name on the value of an index CDS position is less than in the case of a single name CDS position.

A CDS may be cleared so as to protect against a default by the buyer or seller of that CDS. After execution of a CDS by a buyer and seller, for example, a clearinghouse may perform a novation and a become party to multiple credit default swaps (CDSs) with the buyer and seller. In particular, the CDS between the buyer and seller is replaced with a first CDS between the buyer and the clearinghouse as seller, and an identical second CDS between the seller and the clearinghouse as buyer. In practice, a clearinghouse may deal with firms known as clearing members (or “members”). Each member may act for itself and/or on behalf of multiple other parties. As a result, each member may have a large portfolio of CDSs that are cleared through a clearinghouse. In any given portfolio, a member may have positions in multiple different types of CDSs. Some positions may be as a buyer, and some positions may be as a seller.

To help ensure that a member fulfills its obligations under CDSs in its portfolio, a clearinghouse may require the member to provide a margin payment. This margin payment represents a security or performance bond. This is distinguishable from the use of the term “margin” in connection with securities trading, where margin refers to a partial payment of a purchase price. As used herein, the term “margin” refers to a security or performance bond associated with CDS clearing.

### SUMMARY

This Summary is provided to introduce a selection of concepts in a simplified form that are further described below in the Detailed Description. This Summary is not intended to identify key features or essential features of the invention.

In a method according to some embodiments, a computer system may access data describing positions in a portfolio. The portfolio positions may include a position in an index credit default swap corresponding to K separate credit entities. The computer system may calculate at least one margin component based on intrinsic values of the index credit default swap at multiple times t. An intrinsic value at a time t may be represented by a sum of weighted prices, at that time t, of single name credit default swaps corresponding to the K credit entities. The computer system may also calculate data representing a margin requirement that is based at least in part on the at least one margin component and may transmit data representing the margin requirement.

Embodiments include, without limitation, methods for calculating and otherwise processing data related to margin requirements for portfolios that include positions in one or more index credit default swaps, computer systems configured to perform such methods and non-transitory computer-readable media storing instructions executable by a computer system to perform such methods.

### BRIEF DESCRIPTION OF THE DRAWINGS

Some embodiments are illustrated by way of example, and not by way of limitation, in the figures of the accompanying drawings and in which like reference numerals refer to similar elements.

FIG. 1 shows an exemplary trading network environment for implementing systems and methods according to at least some embodiments.

FIG. 2 is a flow chart showing steps in a method according to some embodiments.

FIG. 3 is a flow chart showing additional steps performed based on data generated in the steps of FIG. 2.

### DETAILED DESCRIPTION

In the following description of various embodiments, reference is made to the accompanying drawings, which form a part hereof, and in which various embodiments are shown by way of illustration. It is to be understood that there are other embodiments and that structural and functional modifications may be made. Embodiments of the present invention may take physical form in certain parts and steps, examples of which will be described in detail in the following description and illustrated in the accompanying drawings that form a part hereof.

Various embodiments may comprise a method, a computer system, and/or a computer program product. Accordingly, one or more aspects of one or more of such embodiments may take the form of an entirely hardware embodiment, an entirely software embodiment, and/or an embodiment combining software and hardware aspects. Furthermore, such aspects may take the form of a computer program product stored by one or more non-transitory computer-readable storage media having computer-readable program code, or instructions, embodied in or on the storage media. The term “computer-readable medium” or “computer-readable storage medium” as used herein includes not only a single medium or single type of medium, but also a combination of one or more media and/or types of media. Such a non-transitory computer-readable medium may store computer-readable instructions (e.g., software) and/or computer-readable data (i.e., information that may or may not be executable). Various forms of computer readable media may be utilized, including various types of non-transitory computer readable storage media such as hard disks, CD-ROMs, optical storage devices, magnetic storage devices, FLASH memory and/or any combination thereof. The term “computer-readable medium” or “computer-readable storage medium” could also include an integrated circuit or other device having hard-coded instructions (e.g., logic gates) that configure the device to perform one or more operations.

Aspects of method steps described in connection with one or more embodiments may be executed by one or more processors associated with a computer system (such as exchange computer system 100 described below). As used herein, a “computer system” could be a single computer or could comprise multiple computers. When a computer system comprising multiple computers performs a method, various steps could be performed by different ones of those multiple computers. Processors of a computer system may execute computer-executable instructions stored on non-transitory computer-readable media. Embodiments may also be practiced in a computer system forming a distributed computing environment, with tasks performed by remote processing devices that are linked through a communications network. In a distributed computing environment, program instructions may be stored on local and/or remote computer storage media.

### Exemplary Operating Environment

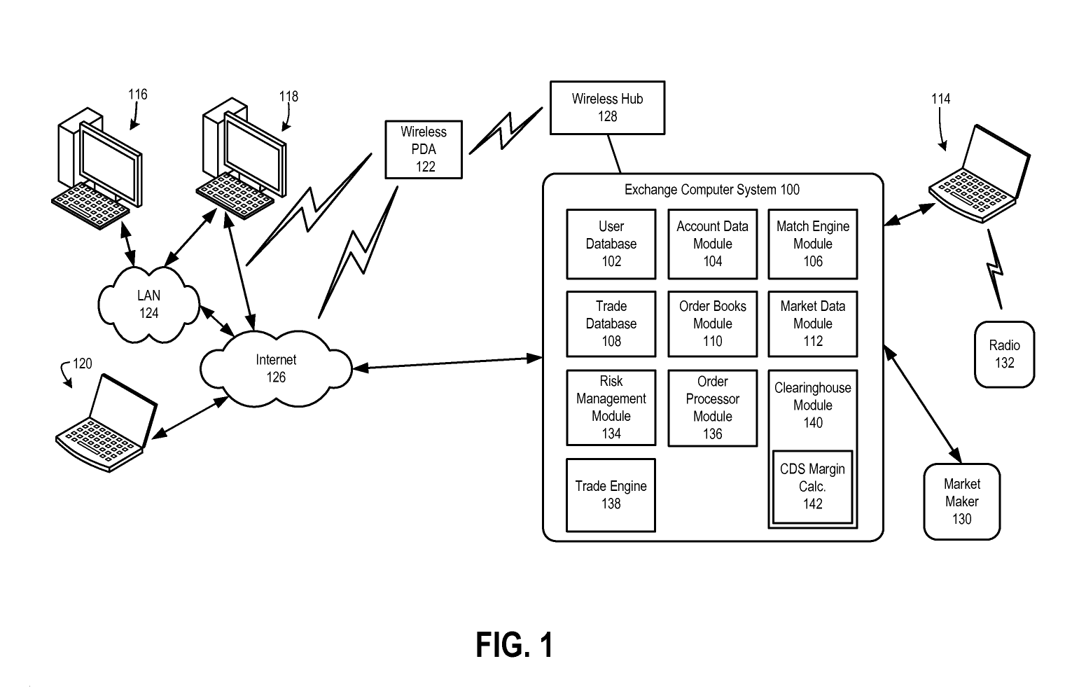

Aspects of at least some embodiments can be implemented with computer systems and computer networks that allow users to communicate trading information. An exemplary trading network environment for implementing systems and methods according to at least some embodiments is shown in FIG. 1. The implemented systems and methods can include systems and methods, such as are described herein, that facilitate data processing and other activities associated with calculation and implementation of margin requirements for portfolios that include one or more positions in one or more CDSs.

Computer system 100 can be operated by a financial product exchange and configured to perform operations of the exchange for, e.g., trading and otherwise processing various financial products. Financial products of the exchange may include, without limitation, futures contracts, options on futures contracts, other types of options, and other types of derivative contracts. Financial products traded, cleared, and/or otherwise processed by the exchange may also include CDSs, including various types of single name CDSs and various types of index CDSs. Financial products traded, cleared, and/or otherwise processed through the exchange may also or alternatively include other types of financial products, including without limitation stocks, bonds and or other securities (e.g., exchange traded funds), foreign currencies, spot market trading of commodities, and over-the-counter (OTC) products such as OTC forwards, OTC options, OTC interest rate swaps, etc.

Computer system 100 receives orders for financial products, matches orders to execute trades, transmits market data related to orders and trades to users, and performs other operations associated with a financial product exchange. Exchange computer system 100 may be implemented with one or more mainframe, desktop or other computers. In one embodiment, a computer device uses a 64-bit processor. A user database 102 includes information identifying traders and other users of exchange computer system 100. Data may include user names and passwords. An account data module 104 may process account information that may be used during trades. A match engine module 106 is included to match prices and other parameters of bid and offer orders. Match engine module 106 may be implemented with software that executes one or more algorithms for matching bids and offers.

A trade database 108 may be included to store information identifying trades and descriptions of trades. In particular, a trade database may store information identifying the time that a trade took place and the contract price. An order book module 110 may be included to store prices and other data for bid and offer orders, and/or to compute (or otherwise determine) current bid and offer prices. A market data module 112 may be included to collect market data, e.g., data regarding current bids and offers for futures contracts, futures contract options and other derivative products. Module 112 may also prepare the collected market data for transmission to users. A risk management module 134 may be included to compute and determine a user's risk utilization in relation to the user's defined risk thresholds. An order processor module 136 may be included to decompose delta based and bulk order types for further processing by order book module 110 and match engine module 106.

A clearinghouse module 140 may be included as part of exchange computer system 100 and configured to carry out operations of a clearinghouse associated with the exchange that operates computer system 100. Module 140 may receive data from and/or transmit data to trade database 108 and/or other modules of computer system 100 regarding trades of CDSs and other financial products traded through the exchange that operates system 100. Clearinghouse module 140 may facilitate the financial product exchange (or a clearinghouse of the exchange) acting as one of the parties to novations of CDSs and other products traded through the exchange, as well as to novations of CDSs and products executed bilaterally or traded through other exchanges but presented to the exchange clearinghouse for clearing. Module 140 may also be configured to perform other clearinghouse operations. As a further example, module 140 may maintain margin data with regard to clearing members. As part of such margin-related operations, module 140 may store and maintain data regarding the values of various CDSs and other interests, determine mark-to-market and final settlement amounts, confirm receipt and/or payment of amounts due from margin accounts, confirm satisfaction of final settlement obligations, etc. CDS margin calculation module 142 may perform some operations of clearinghouse module 140. Such operations may include generating, storing, and/or otherwise processing data regarding margins for portfolios that include positions in one or more index CDSs. Various operations performed by module 142 in at least some embodiments are further described below.

Each of modules 102 through 142 could be implemented as separate software components executing within a single computer, separate hardware components (e.g., dedicated hardware devices) in a single computer, separate computers in a networked computer system, or any combination thereof (e.g., different computers in a networked system may execute software modules corresponding more than one of modules 102-142). When one or more of modules 102 through 142 are implemented as separate computers in a networked environment, those computers may be part of a local area network, a wide area network, and/or multiple interconnected local and/or wide area networks.

Exchange computer system 100 may also communicate in a variety of ways with devices that may be logically distinct from computer system 100. For example, computer device 114 is shown directly connected to exchange computer system 100. Exchange computer system 100 and computer device 114 may be connected via a T1 line, a common local area network (LAN) or other mechanism for connecting computer devices. Also shown in FIG. 1 is a radio 132. The user of radio 132 (e.g., a trader or exchange employee) may transmit orders or other information to a user of computer device 114. The user of computer device 114 may then transmit those orders or other information to exchange computer system 100 using computer device 114.

Computer devices 116 and 118 are coupled to a LAN 124 and may communicate with exchange computer system 100 via LAN 124. LAN 124 may implement one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics, radio links or other media.

A wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet. Computers 116, 118 and 120 may communicate with each other via the Internet 126 and/or LAN 124.

One or more market makers 130 may maintain a market by providing constant bid and offer prices for a derivative or security to exchange computer system 100. Exchange computer system 100 may also include trade engine 138. Trade engine 138 may, e.g., receive incoming communications from various channel partners and route those communications to one or more other modules of exchange computer system 100.

One skilled in the art will appreciate that numerous additional computers and systems may be coupled to exchange computer system 100. Such computers and systems may include, without limitation, additional clearing systems, regulatory systems and fee systems.

The operations of computer devices and systems shown in FIG. 1 and described herein may be controlled by computer-executable instructions stored on one or more non-transitory computer-readable media. For example, computer device 116 may include computer-executable instructions for receiving market data from exchange computer system 100 and displaying that information to a user. As another example, module 142 and/or other modules of exchange computer system 100 may include one or more non-transitory computer-readable media storing computer-executable instructions for performing herein-described operations.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

### Exemplary Embodiments

In at least some embodiments, exchange computer system 100 (or “computer system 100”) receives, stores, generates, and/or otherwise processes data in connection with margins for portfolios that include positions in one or more types of CDSs. In some embodiments, some or all of these operations may be performed by CDS margin calculation module 142. In other embodiments, one or more other modules of computer system 100 may perform some or all of these operations. In still other embodiments, one or more of these operations could be performed by a computer system that is separate from computer system 100.

Periodic payments made by a CDS buyer (the party buying protection) to a CDS seller (the party selling protection) are known as “spread.” A spread is often quoted in terms of basis points (BPS), with each basis point representing 0.01 percent (0.0001) of a notional amount of the CDS. Historically, CDS parties would negotiate the amount of that spread. As CDSs have become standardized, however, spreads are now fixed at a particular value for various types of spreads. In the US, for example, a standard spread is 100 BPS or 500 BPS. The difference between the standardized CDS spread and a spread that parties might have negotiated pre-standardization (hereafter, a “pre-standardization spread”) may be accounted for by an upfront fee that is paid in addition to the standardized spread. In particular, upfront fee may represent a present value, as of CDS execution or other appropriate time, of a difference between a pre-standardization spread and a standardized spread of 100 BPS or 500 BPS. Known models for converting between an upfront fee and a difference between a standard spread and a pre-standardization spread include the International Swaps and Derivative Association (ISDA) Standard CDS model.

An upfront fee may be positive, which represents a payment made by the buyer to the seller, or negative, which represents a payment from the seller to the buyer. Upfront fees may also be quoted in BPS. A “price” of a standardized CDS is conventionally defined as 100 -UF, where “UF” is the upfront fee. Thus, to determine the amount of an upfront fee and the party that will pay it, the CDS price is subtracted from 100 to obtain a UF value in BPS, which UF value is then multiplied by the CDS notional.

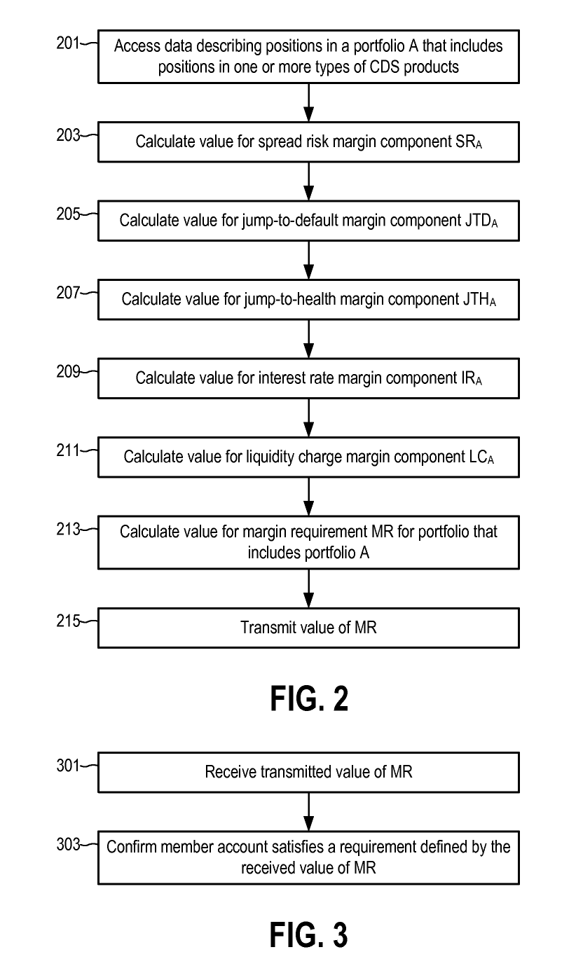

FIG. 2 is a flow chart showing operations performed by computer system 100 in some embodiments. For convenience, FIG. 2 will be described using an example of a portfolio that includes positions in one or more index CDSs of type X. An X index CDS corresponds to a basket of K separate credit entities, where K is an integer. Each of those K credit entities may be a corporation or other type of entity that issues debt instruments. Each of those K credit entities is also the subject of one or more types of single name CDS. In the following discussion, a single name CDS product naming one of the K credit entities included in the X index CDS basket will be referred to as an SNₖ single name CDS, where k is an integer value between 1 and K that corresponds to a particular one of those K credit entities. X index CDSs may be standardized products traded through the exchange that operates computer system 100.

In step 201, module 142 accesses data describing positions in a portfolio A that includes positions in one or more types of CDS products. Portfolio A may be an entire portfolio, or it may be a portion of a larger portfolio that comprises other positions. A “position” refers rights as a buyer or as a seller in a corresponding executed CDS having defined parameters such as named credit entity(ies), default definitions, notional amount, payout amounts, tenor, price (as defined below), etc. Portfolio A includes a position in at least one X index CDS. Portfolio A may or may not include positions in single name CDSs naming one of the K credit entities of an X index CDS.

In step 203, module 142 calculates a spread risk margin component SR_{A} for portfolio A. The spread risk component SR_{A} represents a 99th percentile estimate of an amount that the value of portfolio A might change over a predetermined period (e.g., 5 days) as a result of changes in the value of CDSs corresponding to portfolio A positions. In some embodiments, the algorithm of step 203 generates N scenarios using a Monte Carlo simulation calibrated to data representing spreads for CDSs at multiple times t during a historical reference period, with N=10,000 scenarios n=1 through n=10,000. Using each scenario, a 5-day change in the value of each portfolio A position is estimated. In other embodiments, there may be more or fewer scenarios and/or a different simulation model may be used. For each n^{th} scenario, a value of SR_{A}(n) is calculated, where SR_{A}(n) is an estimate of a 5-day value change for the positions in portfolio A according to scenario n. SR_{A} is then set to equal the 99th percentile value from the 10,000 values of SR_{A}(n) calculated for n=1 through n=10,000.

In the present example of an X index CDS, however, there is a lack of historical data providing values for either (a) pre-standardization spreads that parties might have negotiated for previously executed X index CDSs, or (b) prices of previously executed X index CDSs from which upfront fees (and thus, pre-standardization spreads) can be derived. For example, an X index CDS may be a new product that has not previously traded. Although other types of index CDSs may have been traded, those other index CDSs may have had baskets that included combinations of credit entities significantly different from the K credit entities in an X index CDS basket. However, single name CDSs for the K credit entities named in an X index CDS may have previously been executed and cleared, and there may be data for prices of single name CDSs for each of the K credit entities over the historical reference period.

Because there is insufficient actual spread or price data for X index CDSs during the historical reference period, module 142 calculates spread risk component SR_{A} based on an intrinsic value of an X index CDS at multiple times t during the historical reference period. Those intrinsic values are determined based on the prices for single name CDSs for each of the K credit entities. An intrinsic value Vi(X, t) of an X index CDS at a time t may represent a sum of weighted price values, as of time t, of single name CDSs corresponding to the credit entities named in an X index CDS. Equations 1a and 1b show equivalent representations of Vi(X, t) in analytic form.

$$\begin{matrix}Vi ( X , t ) = P ( {SN}_{1} , t ) * {w}_{1} + P ( {SN}_{2} , t ) * {w}_{2} + … + P ( {SN}_{K} , t ) * {w}_{K} & Equation 1 a \\ Vi ( X , t ) = {\sum }_{k = 1}^{K} P ( {SN}_{k} , t ) * {w}_{k} & Equation 1 b\end{matrix}$$

In Equations 1a and 1b, the element “P(SNₖ, t)” is a price at a time t of an SNk single name CDS, i.e., for a single name CDS naming the k^{th} credit entity of the K credit entities named in an X index CDS. The element “wₖ” is a value for a weighting factor used to account for the inclusion of multiple credit entities named in an X index CDS. Values for wₖ may be determined during construction of the type X index CDS. In some embodiments, wₖ=1/K.

Using the intrinsic values Vi for an X index CDS for each of the multiple times t, module 142 then calculates a derived spread value Sd for each of times t according to Equation 2:

Sd(X, t)=F{Vi(X, t)} Equation 2:

In Equation 2, Sd(X, t) is a derived spread value for an X index CDS as of time t. “F” in Equation 2 represents calculations used to derive a value for a pre-standardization spread from a value for an upfront fee. These calculations can be performed using known models (e.g., the previously-mentioned ISDA Standard CDS model). The values of Sd(X, t), together with values at times t for other products in portfolio A, are then input as calibration for the simulation used to generate the N scenarios when calculating a value of SR_{A}.

In step 205, module 142 calculates a value for a jump-to-default component JTD_{A} for the portfolio A positions. The jump-to-default component JTD_{A} is an estimate of the largest possible loss that might result from a default by a single credit entity named by one or more of the portfolio A positions. In some cases, a given credit entity may be named in multiple portfolio A positions. Some of those positions may correspond to single name CDSs, and some may correspond to index CDSs. Those positions may also include buyer positions and seller positions. As can be appreciated, the default of a single credit entity may increase the value of some positions and may decrease the value of other positions.

In some embodiments, JTD_{A} may estimate losses, apart from spread risk losses, that may result from a default of a single one of the entities represented in portfolio A. In some such embodiments, and for each of j credit entities named in one or more of the portfolio A positions, module 142 first calculates a value JTD(j) in step 205. The value for JTD(j) represents an exposure of portfolio A if there is a default of the j^{th} credit entity and payouts are made based on that default. In some embodiments, JTD(j) value may equal the sum of (1) the mark-to-market (MTM) values, as of default, for all portfolio A positions corresponding to a single name CDS naming the j^{th} credit entity, and (2) the MTM values, as of default, for all portfolio A positions corresponding to an index CDS position including the j^{th} credit entity as a constituent, but with each of those index CDS positions assumed to have a notional equal to 1/R of the index CDS position actual notional (as of the time of JTD(j) calculation), with R being the number of names in the corresponding index CDS. Depending on the nature of each portfolio A position naming the naming the j^{th} credit entity, the value of JTD(j) could be positive or negative.

As the next part of step 205, module 142 computes a value L* representing the largest loss at 99% confidence level in any scenario involving a default of a single credit entity named in one or more of the portfolio A positions. This calculation may be performed according to Equation 3.

$${L}^{*} = - {min}_{j} ( JTD ( j ) - SR ( j ) ) \qquad Equation 3$$

In Equation 3, “SR(j)” is a value for spread risk calculated using the same N scenarios used in connection with step 203, but for a portfolio Aₙₒ_{_}ⱼ that is similar to portfolio A, but with all single name positions naming the j^{th} entity excluded and with notionals of all index positions having a basket that includes the j^{th} entity adjusted to exclude the j^{th} entity. SR(j) is set to equal the 99th percentile value from the 10,000 values of SR(j,n) calculated for n=1 through n=10,000, where SR(j,n) is a value for spread risk of portfolio Aₙₒ_{_}ⱼ under scenario n. The value of jump-to-default component JTD_{A} may then calculated according to Equation 4, where SR_{A} is the value from step 203.

JTD_{A}=max((L*−SR_{A}), 0)

In step 207, module 142 calculates a value for a jump-to-health component JTH_{A} for portfolio A. The jump-to-health component JTH_{A} is used to account for a large, idiosyncratic move in any single name spread. In step 207 according to some embodiments, and for each of j credit entities named in one or more portfolio A positions corresponding to a single name CDS, module 142 first calculates a net value JTH(j) of all portfolio A positions corresponding to a single name CDS naming the j^{th} credit entity. These net values are calculated by assuming spreads for the single name CDSs corresponding to those positions take values given by their 0.5% quantiles.

In the next part of step 207, module 142 computes a value L**, representing the largest loss at 99% confidence level in any scenario with a JTH event. This value may be calculated according to Equation 5.

$${L}^{**} = - {min}_{j} ( JTD ( j ) - {SR}^{′} ( j ) ) \qquad Equation 5$$

In Equation 5, “SR′(j)” is a value for a spread risk calculated using the same N scenarios used in connection with step 203, but for a portfolio A′ₙₒ_{_}ⱼ that is similar to portfolio A, but with all single name positions naming the j^{th} entity excluded. A′(j) is set to equal the 99th percentile value from the 10,000 values of SR′(j,n) calculated for n=1 through n=10,000, where SR′(j,n) is a value for spread risk of portfolio A′ₙₒ_{_}ⱼ under scenario n. The value of jump-to-default component JTH_{A} may then be calculated according to Equation 6, where SR_{A} is the value from step 203.

JTH_{A}=max((L**−SR_{A}), 0) Equation 6:

In step 209, module 142 calculates a value for an interest rate charge component IR_{A} for portfolio A. Interest rate charge component IR_{A} accounts for possible losses associated with changes in an applicable discount curve structure over a designated period (e.g., 5 days). In some embodiments, the ISDA (International Swaps and Derivatives Association) discount curve for USD is used, an upward shift of the curve is assumed, and a resulting change in value of portfolio A (Δᵤₚ) is calculated. Next, a downward shift of the curve is assumed, and a resulting change in value of portfolio A (Δ_{dn}) is calculated. Whichever of Δᵤₚ and Δ_{dn} represents a greater loss is then used as the value of IR_{A}. The magnitudes of the upward and downward shifts are taken to be the 99% quantile of the 5-day log returns for the 5-year point on the ISDA curve, with the quantiles estimated using empirical quantiles based on a 5 year look back period from the date of calculating IR_{A}.

In step 211, module 142 calculates a value for a liquidity charge component LC_{A} for portfolio A. The liquidity charge accounts for extra cost that may be incurred to liquidate portfolio A if position sizes are large relative to market depth of corresponding products. In step 211 according to some embodiments, module 142 first breaks up positions in portfolio A into subportfolios based on the types of corresponding CDS products. For example, one subportfolio may include positions in IG (investment grade) index CDS products, another subportfolio may include positions in HY (high yield) index CDS products, etc. For each subportfolio, a corresponding total exposure is calculated and a corresponding liquid product is identified. With regard to index CDS products for example, the most recent (or “on-the-run”) product tends to be very liquid, while older (or “off-the-run”) products tend have less liquidity. In some embodiments, the on-the-run 5-year CDS product corresponding to the subportfolio is chosen as the liquid product for that subportfolio.

In the present example, trading volume of the X index CDSs is not available. Accordingly, module 142 calculates liquidity risk by breaking down X index CDS positions into a single name basket, calculating the liquidity charge of that basket, and using that charge as a proxy. In some embodiments, module 142 may perform such operations by breaking up each position in an X index CDS into hypothetical positions in a single name CDS for each of the K credit entities named in the X index CDS. Each of those hypothetical single name CDSs may be assumed to have a notional equal to wₖ*N_{X}, where N_{X} is the notional N_{X} of an X index CDS and wₖ is the weight from step 203. Each of those hypothetical single names may then be grouped into a subportfolio with other single name CDSs of portfolio A that name the same credit entity.

For each subportfolio created in step 211, module 142 determines the amount of the corresponding liquid product that would be needed to hedge the corresponding total exposure. Module 142 then compares that amount to recent trading volume of the corresponding liquid product and calculates a liquidity cost for that subportfolio based on the comparison. If the needed amount of the corresponding liquid product is small relative to the current trading volume, then the liquidity cost may be very small. If the needed amount of the corresponding liquid product is large relative to the current trading volume, then the liquidity cost may be larger. In some embodiments, the relationship between needed amount and recent trading volume may be implemented as a look-up table that assigns a liquidity charge to different ranges of H/Q, where H is the amount of liquid product needed to hedge and Q is the trading volume of that liquid product. After calculating a liquidity charge for each subportfolio, the liquidity charges are then summed to obtain LC_{A}.

In step 213, module 142 then calculates margin requirement MR for the portfolio that includes portfolio A. In some embodiments where portfolio A is an entire portfolio, this may be a simple summing of components SR_{A}, JTD_{A}, JTH_{A}, IR_{A} and LC_{A}. In other embodiments, module 142 may perform additional operations to obtain a value for MR. For example, a portfolio that comprises portfolio A may include positions in products other than CDSs, and for which contributions to a margin requirement may be calculated in another manner. As another example, a portfolio may include positions in CDSs denominated in different currencies. In some such embodiments, operations described in connection with FIG. 2 may be combined with operations such as those described in the commonly-owned US patent application titled “Margining Requirements for Multi-Currency CDS Portfolios” (having attorney docket no. 006119.00495 and filed concurrently herewith, which application is incorporated by reference herein) in order to obtain a value for MR.

After calculating a value for MR, and as shown at step 215, module 142 transmits the value for MR to one or more other modules of computer system 100. As seen in FIG. 3, a diagram showing operations performed by those one or more other modules, those one or more other modules may receive the value for MR in step 301. In step 303, those one or more other modules may confirm that a member account corresponding to the portfolio satisfies a requirement defined by the received value for MR. In some embodiments, this may include determining whether the member account contains sufficient funds and/or otherwise indicates collateral having a value equal to or exceeding the value of MR.

Other embodiments may include one or more other variations of the operations described in connection with FIGS. 2 and 3. Various steps in FIGS. 2 and 3 could be rearranged and/or combined with other operations. The margin requirement components described above, e.g., SR_{A}, JTD_{A}, JTH_{A}, IR_{A}, and LC_{A}, could be calculated in alternative ways. In some embodiments, one or more of the components of a margin requirement may be omitted, and/or other components of a margin requirement may be included.

### CONCLUSION

The foregoing description of embodiments has been presented for purposes of illustration and description. The foregoing description is not intended to be exhaustive or to limit embodiments to the precise form explicitly described or mentioned herein. Modifications and variations are possible in light of the above teachings or may be acquired from practice of various embodiments. The embodiments discussed herein were chosen and described in order to explain the principles and the nature of various embodiments and their practical application to enable one skilled in the art to make and use these and other embodiments with various modifications as are suited to the particular use contemplated. Any and all permutations of features from above-described embodiments are the within the scope of the invention.

1. A method comprising:
accessing, by a computer system, data describing positions in a portfolio, the portfolio positions including a position in an index credit default swap corresponding to K separate credit entities;
calculating, by the computer system, at least one margin component based at least in part on intrinsic values of the index credit default swap at multiple times t, wherein each of the intrinsic values of the index credit default swap is represented by
$$Vi ( t ) = {\sum }_{k = 1}^{K} P ( {SN}_{k} , t ) * {w}_{k} ,$$
and wherein Vi(t) is an intrinsic value of the index credit default swap at a time t, P(SNₖ, t) is a value at that time t for a price of a single name credit default swap corresponding to the k^{th} credit entity of the K credit entities, and wₖ is a value for a weighting factor;
calculating, by the computer system, data representing a margin requirement that is based at least in part on the at least one margin component; and
transmitting, by the computer system, data representing the margin requirement.

2. The method of claim 1, wherein calculating the at least one margin component comprises calculating a spread risk margin component.

3. The method of claim 2, wherein calculating the spread risk margin component comprises calculating, for each of the multiple times t and based at least in part on the Vi(t) value for that time t, a value of a derived spread, and generating multiple scenarios using a model calibrated at least in part by the derived spread values.

4. The method of claim 3, wherein calculating the spread risk margin component comprises calculating an estimated value change corresponding to each of the scenarios and selecting a designated percentile value of the estimated value changes as the spread risk margin component.

5. The method of claim 1, wherein calculating the at least one margin component comprises calculating a jump-to-default component and a jump-to-health component.

6. The method of claim 1, wherein calculating data representing the margin requirement comprises calculating an interest charge component and a liquidity charge component.

7. The method of claim 1, further comprising confirming, by the computer system, that a member account contains sufficient funds or other value to satisfy the margin requirement.

8. One or more non-transitory computer-readable media storing computer executable instructions that, when executed, cause a computer system to perform operations that include:
accessing data describing positions in a portfolio, the portfolio positions including a position in an index credit default swap corresponding to K separate credit entities;
calculating at least one margin component based at least in part on intrinsic values of the index credit default swap at multiple times t, wherein each of the intrinsic values of the index credit default swap is represented by
$$Vi ( t ) = {\sum }_{k = 1}^{K} P ( {SN}_{k} , t ) * {w}_{k} ,$$
and wherein Vi(t) is an intrinsic value of the index credit default swap at a time t, P(SNₖ, t) is a value at that time t for a price of a single name credit default swap corresponding to the k^{th} credit entity of the K credit entities, and wₖ is a value for a weighting factor;
calculating data representing a margin requirement that is based at least in part on the at least one margin component; and
transmitting data representing the margin requirement.

9. The one or more non-transitory computer-readable media of claim 8, wherein calculating the at least one margin component comprises calculating a spread risk margin component.

10. The one or more non-transitory computer-readable media of claim 9, wherein calculating the spread risk margin component comprises calculating, for each of the multiple times t and based at least in part on the Vi(t) value for that time t, a value of a derived spread, and generating multiple scenarios using a model calibrated at least in part by the derived spread values.

11. The one or more non-transitory computer-readable media of claim 10, wherein calculating the spread risk margin component comprises calculating an estimated value change corresponding to each of the scenarios and selecting a designated percentile value of the estimated value changes as the spread risk margin component.

12. The one or more non-transitory computer-readable media of claim 8, wherein calculating the at least one margin component comprises calculating a jump-to-default component and a jump-to-health component.

13. The one or more non-transitory computer-readable media of claim 8, wherein calculating data representing the margin requirement comprises calculating an interest charge component and a liquidity charge component.

14. The one or more non-transitory computer-readable media of claim 8, wherein the computer executable instructions include instructions that, when executed, cause a computer system to perform operations that include confirming that a member account contains sufficient funds or other value to satisfy the margin requirement.

15. A computer system comprising:
at least one processor; and
at least one non-transitory memory, wherein the at least one non-transitory memory stores instructions that, when executed, cause the computer system to perform operations that include
accessing data describing positions in a portfolio, the portfolio positions including a position in an index credit default swap corresponding to K separate credit entities,
calculating at least one margin component based at least in part on intrinsic values of the index credit default swap at multiple times t, wherein each of the intrinsic values of the index credit default swap is represented by
$$Vi ( t ) = {\sum }_{k = 1}^{K} P ( {SN}_{k} , t ) * {w}_{k} ,$$
and wherein Vi(t) is an intrinsic value of the index credit default swap at a time t, P(SNₖ, t) is a value at that time t for a price of a single name credit default swap corresponding to the k^{th} credit entity of the K credit entities, and wₖ is a value for a weighting factor,
calculating data representing a margin requirement that is based at least in part on the at least one margin component, and
transmitting data representing the margin requirement.

16. The computer system of claim 15, wherein calculating the at least one margin component comprises calculating a spread risk margin component.

17. The computer system of claim 16, wherein calculating the spread risk margin component comprises calculating, for each of the multiple times t and based at least in part on the Vi(t) value for that time t, a value of a derived spread, and generating multiple scenarios using a model calibrated at least in part by the derived spread values.

18. The computer system of claim 17, wherein calculating the spread risk margin component comprises calculating an estimated value change corresponding to each of the scenarios and selecting a designated percentile value of the estimated value changes as the spread risk margin component.

19. The computer system of claim 15, wherein calculating the at least one margin component comprises calculating a jump-to-default component and a jump-to-health component, and wherein calculating data representing the margin requirement comprises calculating an interest charge component and a liquidity charge component.

20. The computer system of claim 15, wherein the computer executable instructions include instructions that, when executed, cause a computer system to perform operations that include confirming that a member account contains sufficient funds or other value to satisfy the margin requirement.
